(19) United States
(12) Patent Application Publication
(10) Pub. No.: US 2007/0275139 A1
(43) Pub. Date: Nov. 29, 2007

(54) Food compositions comprising renewably-based, biodegradable1,3-propanediol

(76) Inventors: Melissa Joerger, Newark, DE (US); Gyorgyi Fenyvesi, Wilmington, DE (US); Robert Miller, Wilmington, DE (US); Ann Wehner, Hockessin, DE (US)

Correspondence Address: MCCARTER & ENGLISH, LLP;BASIL S. KRIKELIS, Renaissance Centre, 405 N. King Street, 8th Floor, WILMINGTON, DE, 19801, US

(21) Appl. No.: 11/705,197

(22) Filed: Feb. 12, 2007

Related U.S. Application Data
(60) Provisional application No. 60/772,471, filed on Feb. 10, 2006.
(60) Provisional application No. 60/772,194, filed on Feb. 10, 2006.
(60) Provisional application No. 60/772,193, filed on Feb. 10, 2006.
(60) Provisional application No. 60/772,111, filed on Feb. 10, 2006.
(60) Provisional application No. 60/772,120, filed on Feb. 10, 2006.
(60) Provisional application No. 60/772,110, filed on Feb. 10, 2006.
(60) Provisional application No. 60/772,112, filed on Feb. 10, 2006.
(60) Provisional application No. 60/846,948, filed on Sep. 25, 2006.
(60) Provisional application No. 60/853,920, filed on Oct. 24, 2006.
(60) Provisional application No. 60/859,264, filed on Nov. 15, 2006.
(60) Provisional application No. 60/872,705, filed on Dec. 4, 2006.
(60) Provisional application No. 60/880,824, filed on Jan. 17, 2007.

(51) Int. Cl. A23B 7/154

(52) U.S. Cl. 426/321

(57) ABSTRACT

Disclosed herein are food compositions comprising 1,3-propanediol, wherein the 1,3-propanediol in said food composition has a bio-based carbon content of about 1% to 100%. In addition, it is preferred that the 1,3-propanediol be biologically-derived, and wherein upon biodegradation, the biologically-derived 1,3-propanediol contributes no anthropogenic CO₂ emissions to the atmosphere.

### CROSS REFERENCE TO RELATED APPLICATIONS

The present application claims the benefit of U.S. Provisional Application Ser. No. 60/772,471, filed Feb. 10, 2006; U.S. Provisional Application No. 60/772,194, filed Feb. 10, 2006, U.S. Provisional Application No. 60/772,193, filed Feb. 10, 2006, U.S. Provisional Application No. 60/772,111, filed Feb. 10, 2006, U.S. Provisional Application No. 60/772,120, filed Feb. 10, 2006, U.S. Provisional Application No. 60/772,110, filed Feb. 10, 2006, U.S. Provisional Application No. 60/772,112, filed Feb. 10, 2006, U.S. Provisional Application No. 60/846,948, filed Sep. 25, 2006, U.S. Provisional Application No. 60/853,920, filed Oct. 24, 2006, U.S. Provisional Application No. 60/859,264, filed Nov. 15, 2006, U.S. Provisional Application No. 60/872,705, filed Dec. 4, 2006 and U.S. Provisional Application No. 60/880,824, filed Jan. 17, 2007, the disclosures of which are expressly incorporated herein by reference in their entirety.

### FIELD OF THE INVENTION

Disclosed herein are food compositions comprising 1,3-propanediol wherein the 1,3-propanediol in said food composition has a bio-based carbon content of about 1% to 100%. In addition, it is preferred that the 1,3-propanediol be biologically-derived, and wherein upon biodegradation, the biologically-derived 1,3-propanediol contributes no anthropogenic CO₂ emissions to the atmosphere.

### BACKGROUND OF THE INVENTION

Consumers of foods consider many factors in selecting products for use. Recently certain factors have been a focus of and have driven scientific study and product development. These driving factors include, product safety, environmental impact, the extent to which the components are natural, and the aesthetic quality of the overall product. Therefore, manufacturers have to be concerned with the environmental impact of their products. In fact, the effort towards environmental impact awareness is a universal concern, recognized by government agencies. The Kyoto Protocol amendment to the United Nations Framework Convention on Climate Change (UNFCCC) currently signed by 156 nations is one example of a global effort to favor safer environmental manufacturing over cost and efficiency. When applied to foods, consumers are increasingly selective about the origins of the products they purchase. The 2004 Co-operative Bank's annual Ethical Consumerism Report (www.co-operativebank.co.uk) disclosed a 30.3% increase in consumer spending on ethical retail products (a general classification for environmental safe, organic and fair trade goods) between 2003 and 2004 while total consumer spending during the same period rose only 3.7%.

Glycols such as ethylene glycol, propylene glycol, 1,3-butylene glycol, and 2-methyl-1,3-propanediol are biodegradable compounds useful in compositions ranging from cosmetics and personal care formulations to detergents to heat transfer compositions. While biodegradability is an important factor in protecting the environment, biodegradation of glycols derived from fossil-based sources has the unavoidable consequence of releasing previously fixed CO2 into the atmosphere. Thus, while glycols in general are advantageous for their biodegradability, the resulting global warming potential of fossil-based glycols during biodegradation is significant.

Carbon dioxide is singled out as the largest component of the collection of greenhouse gases in the atmosphere. The level of atmospheric carbon dioxide has increased 50% in the last two hundred years. Recent reports indicate that the current level of atmospheric carbon dioxide is higher than the peak level in the late Pleistocene, the epoch before modern humans (Siegenthaler, U. et al. Stable Carbon Cycle-Climate Relationship During the Late Pleistocene, Science, Vol. 310, no. 5752 (Nov. 25, 2005), pp. 1313-1317). Therefore, any further addition of carbon dioxide to the atmosphere is thought to further shift the effect of greenhouse gases from stabilization of global temperatures to that of heating. Consumers and environmental protection groups alike have identified industrial release of carbon into the atmosphere as the source of carbon causing the greenhouse effect.

Greenhouse gas emission can occur at any point during the lifetime of a product. Consumers and environmental groups consider the full lifespan of a product when evaluating a product's environmental impact. Consumers look for products that do not contribute new carbon to the atmosphere considering the environmental impact of production, use and degradation. Only organic products composed of carbon molecules from plant sugars and starches and ultimately atmospheric carbon are considered to not further contribute to the greenhouse effect.

In addition to adding carbon dioxide to the atmosphere, current methods of industrial production of glycols produce contaminants and waste products that include among them sulfuric acid, hydrochloric acid, hydrofluoric acid, phosphoric acid, oxalic acid tartaric acid, acetic acids, Alkali metals, alkaline earth metals, transitional metals and heavy metals, including Iron, cobalt, nickel, copper, silver, molybdenum, tungsten, vanadium, chromium, rhodium, palladium, osmium, iridium, rubidium, and platinum (U.S. Pat. Nos. 2,434,110, 5,034,134, 5,334,778, and 5,10,036).

Also of concern to consumers, especially consumers of food products, is an individual's reaction to such a product. The rate of development of hypersensitivity has markedly increased in the US in the last two decades. Many of these reactions are attributed to trace amount of substances. Other reactions are of idiopathic origin. Consumers seek products that are composed of ingredients of a more purified source and/or of all natural composition.

### SUMMARY OF THE INVENTION

The present invention is directed to a food composition comprising 1,3-propanediol and a food ingredient, wherein said 1,3-propanediol has a bio-based carbon content of at least 1%.

The present invention is also directed to a food composition comprising 1,3-propanediol wherein said 1,3-propanediol has an ultraviolet absorption at 220 nm of less than about 0.200 and at 250 nm of less than about 0.075 and at 275 nm of less than about 0.075.

The present invention is additionally directed to a food composition comprising 1,3-propanediol wherein said 1,3-propanediol has a concentration of total organic impurities of less than about 400 ppm.

The present invention is even further directed to a food composition comprising 1,3-propanediol, wherein the 1,3-propanediol in said composition has an anthropogenic CO₂ emission profile of zero upon biodegradation.

### BRIEF DESCRIPTION OF THE DRAWINGS

FIG. 1 is a graph showing CO₂ emissions for CO₂ fixation from the atmosphere during photosynthesis for renewably based 1,3-propanediol (Bio-PDO™) (−1.7 kg CO₂/kg product) and CO₂ release to the atmosphere during biodegradation (kg CO₂/kg product) for ethylene glycol (EG) (+1.4 kg CO₂/kg product), propylene glycol (PG) (+1.7 kg CO₂kg/product), fossil-based 1,3-propanediol (Chem-PDO) (+1.7 kg CO₂/kg product), and fermentatively-derived 1,3-propanediol (Bio-PDO™) (+1.7 kg CO₂/kg product).

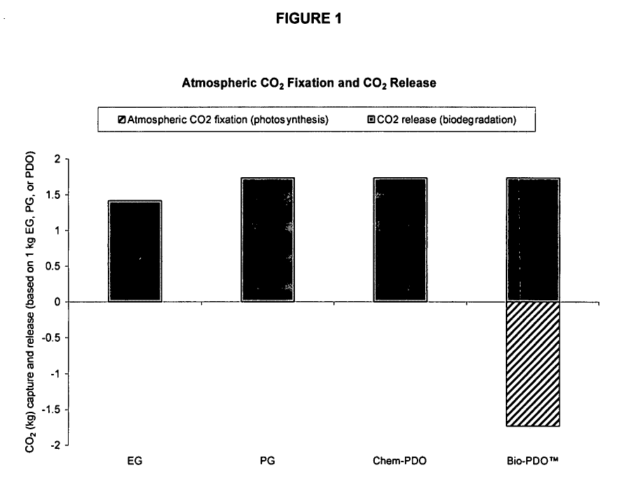

FIG. 2 is a graph showing that the net emissions of CO₂ to the atmosphere for renewably based 1,3-propanediol (Bio-PDO) is zero (0).

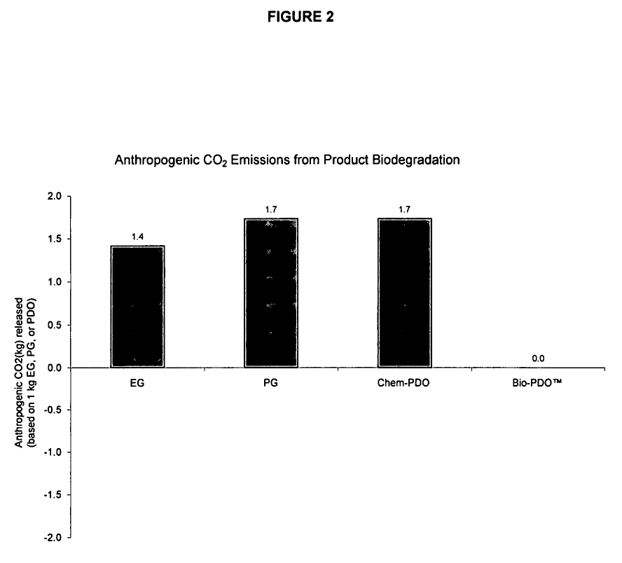

FIG. 3 is a table that shows the calculations for the data shown in FIGS. 1 and 2.

### DETAILED DESCRIPTION OF THE INVENTION

Applicants specifically incorporate the entire content of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Compositions disclosed herein comprise 1,3-propanediol, having at least 1% bio-based carbon content, as greater as up to 100% of the glycol component of the composition. In one embodiment, the 1,3-propanediol comprises substantially all of the glycol component of the composition of the invention. In another embodiment, the 1,3-propanediol comprises all of the glycol component of the composition.

1,3-Propanediol

The terms “bioPDO”, “biologically-derived, biodegradable 1,3-propanediol”, “biologically derived 1,3-propanediol”, “renewably-based 1,3-propanediol”, “renewably-based, biodegradable 1,3-propanediol,” “biosourced, and “biologically-produced 1,3-propanediol” and similar terms as used here in refer to 1,3-propanediol derived from microorganism metabolism of plant-derived sugars composed of carbon of atmospheric origin, and not composed of fossil-fuel carbon.

Anthropogenic CO₂ Emission Profile

Applicants' invention relates to food compositions comprising renewably-based, biodegradable 1,3-propanediol, in which said renewably-based, biodegradable 1,3-propanediol has an anthropogenic CO₂ emission profile of zero (0). An “anthropogenic emission profile” means anthropogenic CO₂ emissions that are contributed to the atmosphere upon biodegradation of a compound or composition. p

“Biodegradable” or “Biodegradability” means the capacity of a compound to be broken down by living organisms to simple, stable compounds such as carbon dioxide and water.

Whereas photosynthesis is the process of creating growing matter through the conversion of carbon dioxide (CO₂) and water (H₂O) into plant material through the action of the sun, biodegradation is the process of converting organic material back into CO₂ and H₂O through the activity of living organisms.

There are many published test methods for measuring the biodegradability of organic chemicals such as glycols. One internationally recognized method is ASTM E1720-01, Standard Test Method for Determining Ready, Ultimate Biodegradability of Organic Chemicals in a Sealed Vessel CO₂ Production Test.

Chemicals that demonstrate 60% biodegradation or better in this test method will biodegrade in most aerobic environments and are classified as ready biodegradable. All of the glycols referred to in this document meet this criteria.

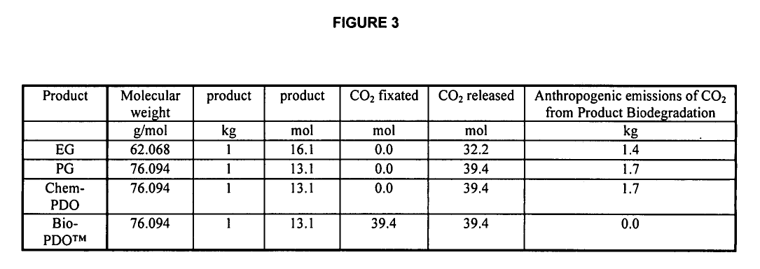

Calculations setting forth the finding that the 1,3-propanediol of the present invention provides no anthropogenic COs emissions upon biodegradation is set forth below. A table in support of these calculations is provided in FIG. 3.

When one molecule of 1,3-propanediol degrades, three molecules of CO₂ are released into the atmosphere. Because all of these molecules of CO₂ released during degradation from “fermentatively-derived” 1,3-propanediol have an atmospheric origin, the net release of CO₂ to the atmosphere is thus zero. Comparatively, because a fossil fuel-derived propylene glycol and fossil-derived 1,3-propanediol contains three carbon atoms which originate from a fixed carbon source (i.e., the fossil fuel), degradation of one molecule of fossil fuel-derived propylene glycol or 1,3-propanediol results in a net release of three molecules of CO₂ into the atmosphere. Similarly, because fossil fuel-derived ethylene glycol contains two carbon atoms, which originate from a fixed carbon source, degradation of one molecule of fossil fuel-derived ethylene glycol results in a net release of two molecules of CO₂ into the atmosphere.

In order to quantify the CO₂ released for one kilogram of each ethylene glycol, propylene glycol, chemical 1,3-propanediol and “fermentatively-derived” 1,3 propanediol (Bio-PDO™), the product weight (1 kg) is divided by its molecular weight. For each carbon atom present in the molecule, one molecule of CO₂ is released. The molecules of CO₂ are multiplied by the molecular weight of CO₂ (44 kg/kmole) to quantify the impact of CO₂ release (kg) per one unit (kg) of product.

Fossil-Fuel Based Carbon Feedstock Release

1 kg of fossil fuel derived ethylene glycol*(1 kmol EG/62.068 kg)*(2 kmol CO₂/1 kmol EG)*(44 kg CO₂/kmol CO₂)=1.4 kg CO₂

1 kg of fossil fuel derived propylene glycol*(1 kmol PG/76.094 kg)*(3 kmol CO₂/1 kmol PG)*(44 kg CO₂/kmol CO₂)=1.7 kg CO₂

1 kg of fossil fuel derived 1,3-propanediol*(1 kmol chem-PDO/76.094 kg)*(3 kmol CO₂/1 kmol chem-PDO)*(44 kg CO₂/kmol CO₂)=1.7 kg CO₂

Bio-Based Carbon Feedstock Balance

Capture:

1 kg of Bio-PDO™*(1 kmol Bio-PDO™/76.094 kg)*(−3 kmol CO₂/1 kmol Bio-PDO™)*(44 kg CO₂/kmol CO₂)=−1.7 kg CO₂

Release:

1 kg of Bio-PDO™*(1 kmol Bio-PDO™/76.094 kg)*(3 kmol CO₂/1 kmol Bio-PDO™)*(44 kg CO₂/kmol CO₂)=1.7 kg CO₂

Net:

−1.7 kg+1.7 kg=0 kg

This Bio-based Carbon Feedstock Balance result demonstrates that there are no anthropogenic CO₂ emissions from the biodegradation of the renewably sourced Bio-PDO. The term “anthropogenic” means man-made or fossil-derived.

Bio-Based Carbon

“Carbon of atmospheric origin” as used herein refers to carbon atoms from carbon dioxide molecules that have recently, in the last few decades, been free in the earth's atmosphere. Such carbons in mass are identifiable by the present of particular radioisotopes as described herein. “Green carbon”, “atmospheric carbon”, “environmentally friendly carbon”, “life-cycle carbon”, “non-fossil fuel based carbon”, “non-petroleum based carbon”, “carbon of atmospheric origin”, and “biobased carbon” are used synonymously herein.

“Carbon of fossil origin” as used herein refers to carbon of petrochemical origin. Such carbon has not been exposed to UV rays as atmospheric carbon has, therefore masses of carbon of fossil origin has few radioisotopes in their population. Carbon of fossil origin is identifiable by means described herein. “Fossil fuel carbon”, “fossil carbon”, “polluting carbon”, “petrochemical carbon”, “petro-carbon” and carbon of fossil origin are used synonymously herein.

The abbreviation “IRMS” refers to measurements of CO₂ by high precision stable isotope ratio mass spectrometry.

The term “carbon substrate” means any carbon source capable of being metabolized by a microorganism wherein the substrate contains at least one carbon atom.

“Renewably-based” denotes that the carbon content of the 1,3-propanediol is from a “new carbon” source as measured by ASTM test method D 6866-05 Determining the Biobased Content of Natural Range Materials Using Radiocarbon and Isotope Ratio Mass Spectrometry Analysis, incorporated herein by reference. This test method measures the C-14/C-12 isotope ratio in a sample and compares it to the C-14/C-12 isotope ratio in a standard 100% biobased material to give percent biobased content of the sample. “Biobased materials” are organic materials in which the carbon comes from recently (on a human time scale) fixated CO₂ present in the atmosphere using sunlight energy (photosynthesis). On land, this CO₂ is captured or fixated by plant life (e.g., agricultural crops or forestry materials). In the oceans, the CO₂ is captured or fixated by photosynthesizing bacteria or phytoplankton. A biobased material has a C-14/C-12 isotope ratio in range of from 1:0 to greater than 0:1. Contrarily, a fossil-based material, has a C-14/C-12 isotope ratio of 0:1.

A small amount of the carbon dioxide in the atmosphere is radioactive. This 14C carbon dioxide is created when nitrogen is struck by an ultra-violet light produced neutron, causing the nitrogen to lose a proton and form carbon of molecular weight 14 which is immediately oxidized in carbon dioxide. This radioactive isotope represents a small but measurable fraction of atmospheric carbon. Atmospheric carbon dioxide is cycled by green plants to make organic molecules during the process known as photosynthesis. The cycle is completed when the green plants or other forms of life metabolize the organic molecules producing carbon dioxide which is released back to the atmosphere. Virtually all forms of life on Earth depend on this green plant production of organic molecule to produce the chemical energy that facilitates growth and reproduction. Therefore, the 14C that exists in the atmosphere becomes part of all life forms, and their biological products. These renewably based organic molecules that biodegrade to CO2 do not contribute to global warming as there is no net increase of carbon emitted to the atmosphere. In contrast, fossil fuel based carbon does not have the signature radiocarbon ratio of atmospheric carbon dioxide.

Atmospheric origin and fixed carbon source as used herein are relative terms in that the time period of when CO2 is of atmospheric or fixed origin relates to the life cycle of the 1,3-propanediol. Thus, while it is quite possible that, at one time, carbon from a fossil fuel was found in the atmosphere (and, as a corollary, that atmospheric CO2 may one day be incorporated into a fixed carbon source), for purposes herein carbon is considered to be from a fixed carbon source until it is released into the atmosphere by degradation.

Assessment of the renewably based carbon in a material can be performed through standard test methods. Using radiocarbon and isotope ratio mass spectrometry analysis, the biobased content of materials can be determined. ASTM International, formally known as the American Society for Testing and Materials, has established a standard method for assessing the biobased content of materials. The ASTM method is designated ASTM-D6866.

The application of ASTM-D6866 to derive a “biobased content” is built on the same concepts as radiocarbon dating, but without use of the age equations. The analysis is performed by deriving a ratio of the amount of radiocarbon (14C) in an unknown sample to that of a modem reference standard. The ratio is reported as a percentage with the units “pMC” (percent modern carbon). If the material being analyzed is a mixture of present day radiocarbon and fossil carbon (containing no radiocarbon), then the pMC value obtained correlates directly to the amount of Biomass material present in the sample.

The modern reference standard used in radiocarbon dating is a NIST (National Institute of Standards and Technology) standard with a known radiocarbon content equivalent approximately to the year AD 1950. AD 1950 was chosen since it represented a time prior to thermo-nuclear weapons testing which introduced large amounts of excess radiocarbon into the atmosphere with each explosion (termed “bomb carbon”). The AD 1950 reference represents 100 pMC.

“Bomb carbon” in the atmosphere reached almost twice normal levels in 1963 at the peak of testing and prior to the treaty halting the testing. Its distribution within the atmosphere has been approximated since its appearance, showing values that are greater than 100 pMC for plants and animals living since AD 1950. It's gradually decreased over time with today's value being near 107.5 pMC. This means that a fresh biomass material such as corn could give a radiocarbon signature near 107.5 pMC.

Combining fossil carbon with present day carbon into a material will result in a dilution of the present day pMC content. By presuming 107.5 pMC represents present day biomass materials and 0 pMC represents petroleum derivatives, the measured pMC value for that material will reflect the proportions of the two component types. A material derived 100% from present day soybeans would give a radiocarbon signature near 107.5 pMC. If that material was diluted with 50% petroleum derivatives, it would give a radiocarbon signature near 54 pMC.

A biomass content result is derived by assigning 100% equal to 107.5 pMC and 0% equal to 0 pMC. In this regard, a sample measuring 99 pMC will give an equivalent biobased content result of 93%.

A sample of “fermentatively-derived” 1,3-propanediol was submitted by DuPont to Iowa State University for biobased content analysis using ASTM method D 6866-05. The results received from Iowa State University demonstrated that the above sample was 100% bio-based content (ref: Norton, Glenn. Results of Radiocarbon Analyses on samples from DuPont Bio-Based Materials—reported Jul. 8, 2005).

Assessment of the materials described herein were done in accordance with ASTM-D6866. The mean values quoted in this report encompasses an absolute range of 6% (plus and minus 3% on either side of the biobased content value) to account for variations in end-component radiocarbon signatures. It is presumed that all materials are present day or fossil in origin and that the desired result is the amount of biobased component “present” in the material, not the amount of biobased material “used” in the manufacturing process.

Results of Radiocarbon Analyses on Samples from DuPont Bio-Based Materials

Reported Jul. 8, 2005

| PRODUCT | BIOBASED CONTENT (%) |
|---|---|
| 1,3-Propanediol | 100 |

There may be certain instances wherein a food composition of the invention may comprise a combination of a biologically-derived 1,3-propanediol and one or more non biologically-derived glycol components, such as, for example, chemically synthesized 1,3-propanediol. In such occasions, it may be difficult, if not impossible to determine which percentage of the glycol composition is biologically-derived, other than by calculating the bio-based carbon content of the glycol component. In this regard, in the food compositions of the invention, the glycol component, and in particular, the 1,3-propanediol, can comprise at least about 1% bio-based carbon content up to 100% bio-based carbon content, and any percentage therebetween.

Purity

“Substantially purified,” as used by applicants to describe the biologically-produced 1,3-propanediol produced by the process of the invention, denotes a composition comprising 1,3-propanediol having at least one of the following characteristics: 1) an ultraviolet absorption at 220 nm of less than about 0.200 and at 250 nm of less than about 0.075 and at 275 nm of less than about 0.075; or 2) a composition having L*a*b* “b*” color value of less than about 0.15 and an absorbance at 270 nm of less than about 0.075; or 3) a peroxide composition of less than about 10 ppm; or 4) a concentration of total organic impurities of less than about 400 ppm.

A “b*” value is the spectrophotometrically determined “Yellow Blue measurement as defined by the CIE L*a*b* measurement ASTM D6290.

The abbreviation “AMS” refers to accelerator mass spectrometry.

By the acronym “NMR” is meant nuclear magnetic resonance.

By the terms “color” and “color bodies” is meant the existence of visible color that can be quantified using a spectrocolorimeter in the range of visible light, using wavelengths of approximately 400-800 nm, and by comparison with pure water. Reaction conditions can have an important effect on the nature of color production. Examples of relevant conditions include the temperatures used, the catalyst and amount of catalyst. While not wishing to be bound by theory, we believe color precursors include trace amounts of impurities comprising olefinic bonds, acetals and other carbonyl compounds, peroxides, etc. At least some of these impurities may be detected by such methods as UV spectroscopy, or peroxide titration.

“Color index” refers to an analytic measure of the electromagnetic radiation-absorbing properties of a substance or compound.

Biologically-derived 1,3-propanediol useful in food compositions disclosed herein has at least one of the following characteristics: 1) an ultraviolet absorption at 220 nm of less than about 0.200 and at 250 nm of less than about 0.075 and at 275 nm of less than about 0.075; or 2) a composition having L*a*b*“b*” color value of less than about 0.15 and an absorbance at 270 nm of less than about 0.075; or 3) a peroxide composition of less than about 10 ppm; or 4) a concentration of total organic impurities of less than about 400 ppm. A “b*” value is the spectrophotometrically determined Yellow Blue measurement as defined by the CIE L*a*b* measurement ASTM D6290.

The level of 1,3-propanediol purity can be characterized in a number of different ways. For example, measuring the remaining levels of contaminating organic impurities is one useful measure. Biologically-derived 1,3-propanediol can have a purity level of less than about 400 ppm total organic contaminants; preferably less than about 300 ppm; and most preferably less than about 150 ppm. The term ppm total organic purity refers to parts per million levels of carbon-containing compounds (other than 1,3-propanediol) as measured by gas chromatography.

Biologically-derived 1,3-propanediol can also be characterized using a number of other parameters, such as ultraviolet light absorbance at varying wavelengths. The wavelengths 220 nm, 240 nm and 270 nm have been found to be useful in determining purity levels of the composition. Biologically-derived 1,3-propanediol can have a purity level wherein the UV absorption at 220 nm is less than about 0.200 and at 240 nm is less than about 0.075 and at 270 nm is less than about 0.075.

Biologically-derived 1,3-propanediol can have a b* color value (CIE L*a*b*) of less than about 0.15.

The purity of biologically-derived 1,3-propanediol compositions can also be assessed in a meaningful way by measuring levels of peroxide. Biologically-derived 1,3-propanediol can have a concentration of peroxide of less than about 10 ppm.

It is believed that the aforementioned purity level parameters for biologically-derived and purified 1,3-propanediol (using methods similar or comparable to those disclosed in U.S. Patent Application No. 2005/0069997) distinguishes such compositions from 1,3-propanediol compositions prepared from chemically purified 1,3-propanediol derived from petroleum sources, as per the prior art.

Fermentation

“Biologically produced” means organic compounds produced by one or more species or strains of living organisms, including particularly strains of bacteria, yeast, fungus and other microbes. “Bio-produced” and biologically produced are used synonymously herein. Such organic compounds are composed of carbon from atmospheric carbon dioxide converted to sugars and starches by green plants.

“Biologically-based” means that the organic compound is synthesized from biologically produced organic components. It is further contemplated that the synthesis process disclosed herein is capable of effectively synthesizing other monoesters and diesters from bio-produced alcohols other than 1,3-propanediol; particularly including ethylene glycol, diethylene glycol, triethylene glycol, 1,2-propylene glycol, dipropylene diol, tripropylene diol, 2-methyl 1,3-propanediol, neopentyl glycol and bisphenol A. “Bio-based”, and “bio-sourced”; “biologically derived”; and “bio-derived” are used synonymously herein.

“Fermentation” as used refers to the process of metabolizing simple sugars into other organic compounds. As used herein fermentation specifically refers to the metabolism of plant derived sugars, such sugar are composed of carbon of atmospheric origin.

Biologically-derived 1,3-propanediol can be obtained based upon use of the fermentation broth (“fermentatively-derived”) generated by a genetically-engineered Eschericia coli (E. coli) previously disclosed in, for example, U.S. Pat. No. 5,686,276. However, other single organisms, or combinations of organisms, may be used to biologically produce 1,3-propanediol, using organisms that have been genetically-engineered according to methods known in the art. “Fermentation” refers to a system that catalyzes a reaction between substrate(s) and other nutrients to product(s) through use of a biocatalyst. The biocatalysts can be a whole organism, an isolated enzyme, or any combination or component thereof that is enzymatically active. Fermentation systems useful for producing and purifying biologically-derived 1,3-propanediol are disclosed in, for example, Published U.S. Patent Application No. 2005/0069997 incorporated herein by reference.

The biologically derived 1,3-propanediol (Bio-PDO) for use in the current invention, produced by the process described herein, contains carbon from the atmosphere incorporated by plants, which compose the feedstock for the production of Bio-PDO. In this way, the Bio-PDO used in the compositions of the invention contains only renewable carbon, and not fossil fuel based, or petroleum based carbon. Therefore the compositions of the invention have less impact on the environment as the propanediol used in the compositions does not deplete diminishing fossil fuels and, upon degradation releases carbon back to the atmosphere for use by plants once again. Thus, the present invention can be characterized as more natural and having less environmental impact than similar compositions comprising petroleum based glycols.

Moreover, as the purity of the Bio-PDO utilized in the compositions of the invention is higher than chemically synthesized 1,3-propanediol and other glycols, risk of introducing impurities that may cause irritation is reduced by its use over commonly used glycols, such as propylene glycol.

This 1,3-propanediol of the invention can be isolated from the fermentation broth and is incorporated into food compositions of the invention, by processes as are known to those of ordinary skill in the applicable art.

Renewably-Based, Biodegradable 1,3-Propanediol-Containing Food Compositions

As mentioned above, 1,3-propanediol can be incorporated into numerous compositions as a glycol component. For example, 1,3-propanediol can be part of or the sole glycol component of food compositions.

It is contemplated herein that other renewably-based or biologically-derived glycols, such as ethylene glycol, dietheylene glycol, triethylene glycol, 1,2 propylene glycol, dipropylene glycol, tripropylene glycol, neopentyl glycol and bisphenol A, among others, can be used in the food compositions of the present invention.

Because the Bio-PDO of the invention can be produced from renewable resources, it is economically and readily available in commercial quantities. It is expected that the Bio-PDO based food and feed compositions can be produced more inexpensively than chemical PDO or other chemical glycol-based compositions.

The food compositions of the invention include a food or food component consisting of one or more food ingredients. Further, a food composition includes human food, substances migrating to food from food-contact articles, beverages, pet food, and animal feed compositions.

A “food ingredient” includes any ingredient that can be used in a food composition. It is preferred that an ingredient be of appropriate food grade; that it be prepared and handled as a food ingredient; and that the quantity of the ingredient added to food does not exceed the amount reasonably required to accomplish the intended physical, nutritional, or other technical effect in food.

Food compositions of the invention can comprise from 0.1% to 100% Bio-PDO by weight, and more preferably from about 2% to about 97% Bio-PDO by weight. A typical food composition formulation of the present invention could include 2% to 97% Bio-PDO and 3% to 98% of one or more ingredients.

In the food compositions of the invention, the Bio-PDO can be an anticaking agent, free-flow agent, antioxidant, dough strengthener, emulsifier, emulsifier salt, flavoring agent, flavoring adjuvant, formulation aid, humectant, processing aid, solvent, vehicle, stabilizer, thickener, surface-active agent, and/or texturizer.

As they relate to the function of the Bio-PDO in the food compositions of the invention, the following definitions are applicable.

“Anticaking agents and free-flow agents” are generally defined as substances added to finely powdered or crystalline food products to prevent caking, lumping, or agglomeration.

“Antioxidants” are generally defined as substances used to preserve food by retarding deterioration, rancidity, or discoloration due to oxidation.

“Dough strengtheners” are generally defined as substances used to modify starch and gluten, thereby producing a more stable dough, including the applicable effects listed by the National Academy of Sciences/National Research Council under “dough conditioner.”

“Emulsifiers and emulsifier salts” are generally defined as substances which modify surface tension in the component phase of an emulsion to establish a uniform dispersion or emulsion.

“Flavoring agents and adjuvants” are generally defined as substances added to impart or help impart a taste or aroma in food.

“Formulation aids” are generally defined as substances used to promote or produce a desired physical state or texture in food, including carriers, binders, fillers, plasticizers, film-formers, and tableting aids, etc.

“Humectants” are generally defined as hygroscopic substances incorporated in food to promote retention of moisture, including moisture-retention agents and antidusting agents.

“Processing aids” are generally defined as substances used as manufacturing aids to enhance the appeal or utility of a food or food component, including clarifying agents, clouding agents, catalysts, flocculents, filter aids, and crystallization inhibitors, etc.

“Solvents and vehicles” are generally defined as substances used to extract or dissolve another substance.

“Stabilizers and thickeners” are generally defined as substances used to produce viscous solutions or dispersions, to impart body, improve consistency, or stabilize emulsions, including suspending and bodying agents, setting agents, jellying agents, and bulking agents, etc.

“Surface-active agents” are generally defined as substances used to modify surface properties of liquid food components for a variety of effects, other than emulsifiers, but including solubilizing agents, dispersants, detergents, wetting agents, rehydration enhancers, whipping agents, foaming agents, and defoaming agents, etc.

“Texturizers” are generally defined as substances which affect the appearance or feel of the food.

Food Ingredients

As described above, in a preferred embodiment, the food composition of the invention comprises the 1,3-propanediol of the invention and at least one food ingredient. Below is a non-limiting description of ingredients that can be used in the food compositions of the invention.

The U.S. Food and Drug Administration (FDA) Center for Food Safety and Applied Nutrition (CFSAN) maintains a database (“EAFUS: A Food Additive database”; http://vm.cfsan.fda.gov/˜dms/eafus.html) under an ongoing program known as the Priority-based Assessment of Food Additives (PAFA). PAFA contains administrative, chemical and toxicological information on over 2000 substances directly added to food, including substances regulated by the U.S. FDA as direct, “secondary” direct, and color additives, and Generally Recognized As Safe (GRAS) and prior-sanctioned substances. In addition, the database contains only administrative and chemical information on less than 1000 such substances. The more than 3000 total substances together comprise an inventory often referred to as “Everything” Added to Food in the United States (EAFUS). It is contemplated that all ingredients listed in the EAFUS can be used as ingredients in the food compositions of the invention, and those having skill in the art can readily determine appropriate ingredients for particular food products. The EAFUS Food Additive Database described above is herein incorporated by reference in its entirety.

The EAFUS list of substances contains ingredients added directly to food that FDA has either approved as food additives or listed or affirmed as GRAS. Nevertheless, it contains only a partial list of all food ingredients that may in fact be lawfully added to food, because under federal law some ingredients may be added to food under a GRAS determination made independently from the FDA. The list contains many, but not all, of the substances subject to independent GRAS determinations. For information about the GRAS notification program please consult the Inventory of GRAS Notifications. Additional information on the status of Food and Color Additives can be obtained from the Food Additive Status List or the Color Additive Status List (formerly called Appendix A of the Investigations Operations Manual).

The following summary is copied directly from the EAFUS Food d Additive Database and lists certain types of common food ingredients, why they are used, and some examples of the names that can be found on product labels. Some additives are used for more than one purpose.

The ingredient listings below are organized as follows:

Ingredient Category

Ingredient Function
Food Category
Ingredient Example

Preservatives
Prevent food spoilage from bacteria, molds, fungi, or yeast (antimicrobials); slow or prevent changes in color, flavor, or texture and delay rancidity (antioxidants); maintain freshness
Fruit sauces and jellies, beverages, baked goods, cured meats, oils and margarines, cereals, dressings, snack foods, fruits and vegetables
Ascorbic acid, citric acid, sodium benzoate, calcium propionate, sodium erythorbate, sodium nitrite, calcium sorbate, potassium sorbate, BHA, BHT, EDTA, tocopherols (Vitamin E)

Sweeteners
Add sweetness with or without the extra calories
Beverages, baked goods, confections, table-top sugar, substitutes, many processed foods
Sucrose (sugar), glucose, fructose, sorbitol, mannitol, corn syrup, high fructose corn syrup, saccharin, aspartame, sucralose, acesulfame potassium (acesulfame-K), neotame

Color Additives
Offset color loss due to exposure to light, air, temperature extremes, moisture and storage conditions; correct natural variations in color; enhance colors that occur naturally; provide color to colorless and “fun” foods
Many processed foods, (candies, snack foods margarine, cheese, soft drinks, jams/jellies, gelatins, pudding and pie fillings)
FD&C Blue Nos. 1 and 2, FD&C Green No. 3, FD&C Red Nos. 3 and 40, FD&C Yellow Nos. 5 and 6, Orange B, Citrus Red No. 2, annatto extract, beta-carotene, grape skin extract, cochineal extract or carmine, paprika oleoresin, caramel color, fruit and vegetable juices, saffron (Note: Exempt color additives are not required to be declared by name on labels but may be declared simply as colorings or color added)

Flavors and Spices
Add specific flavors (natural and synthetic)
Pudding and pie fillings, gelatin dessert mixes, cake mixes, salad dressings, candies, soft drinks, ice cream, BBQ sauce
Natural flavoring, artificial flavor, and spices

Flavor Enhancers
Enhance flavors already present in foods (without providing their own separate flavor)
Many processed foods
Monosodium glutamate (MSG), hydrolyzed soy protein, autolyzed yeast extract, disodium guanylate or inosinate

Fat Replacers (and Components of Formulations Used to Replace Fats)
Provide expected texture and a creamy “mouth-feel” in reduced-fat foods
Baked goods, dressings, frozen desserts, confections, cake and dessert mixes, dairy products
Olestra, cellulose gel, carrageenan, polydextrose, modified food starch, microparticulated egg white protein, guar gum, xanthan gum, whey protein concentrate

Nutrients
Replace vitamins and minerals lost in processing (enrichment), add nutrients that may be lacking in the diet (fortification)
Flour, breads, cereals, rice, macaroni, margarine, salt, milk, fruit beverages, energy bars, instant breakfast drinks
Thiamine hydrochloride, riboflavin (Vitamin B2), niacin, niacinamide, folate or folic acid, beta carotene, potassium iodide, iron or ferrous sulfate, alpha tocopherols, ascorbic acid, Vitamin D, amino acids (L-ryptophan, L-lysine, L-leucine, L-methionine)

Emulsifiers
Allow smooth mixing of ingredients, prevent separation. Keep emulsified products stable, reduce stickiness, control crystallization, keep ingredients dispersed, and to help products dissolve more easily
Salad dressings, peanut butter, chocolate, margarine, frozen desserts
Soy lecithin, mono- and diglycerides, egg yolks, polysorbates, sorbitan monostearate

Stabilizers and Thickeners, Binders, Texturizers
Produce uniform texture, improve “mouth-feel”
Frozen desserts, dairy products, cakes, pudding and gelatin mixes, dressings, jams and jellies, sauces
Gelatin, pectin, guar gum, carrageenan, xanthan gum, whey

pH Control Agents and acidulants
Control acidity and alkalinity, prevent spoilage
Beverages, frozen desserts, chocolate, low acid canned foods, baking powder
Lactic acid, citric acid, ammonium hydroxide, sodium carbonate

Leavening Agents
Promote rising of baked goods
Breads and other baked goods
Baking soda, monocalcium phosphate, calcium carbonate

Anti-Caking Agents
Keep powdered foods free-flowing, prevent moisture absorption
Salt, baking powder, confectioner's sugar
Calcium silicate, iron ammonium citrate, silicon dioxide

Humectants
Retain moisture
Shredded coconut, marshmallows, soft candies, confections
Glycerin, sorbitol, Propylene Glycol

Yeast Nutrients
Promote growth of yeast
Breads and other baked goods
Calcium sulfate, ammonium phosphate

Dough Strengtheners and Conditioners
Produce more stable dough
Breads and other baked goods
Ammonium sulfate, azodicarbonamide, L-cysteine

Firming Agents
Maintain crispness and firmness
Processed fruits and vegetables
Calcium chloride, calcium lactate

Enzyme Preparations
Modify proteins, polysaccharides and fats
Cheese, dairy products, meat
Enzymes, lactase, papain, rennet, chymosin

Gases
Serve as propellant, aerate, or create carbonation
Oil cooking spray, whipped cream, carbonated beverages
Carbon dioxide, nitrous oxide

In addition, esters can function as many of the above noted ingredients. While those in those having skill in the art can readily determine which esters are most appropriate to provide a particularly desired function, applications specifically note that esters used in this invention may include the esters produced, including all the appropriate conjugate mono and diesters, from biologically-derived 1,3 propanediol using organic carboxylic acids. Some esters in particular that are produced include propanediol distearate and monostearate, propandiol dilaurate and monolaurate, propanediol dioleate and monooleate, propanediol divalerate and monovalerate, propanediol dicaprylate and monocaprylate, propanediol dimyristate and monomyristate, propanediol dipalmitate and monopalmitate, propanediol dibehenate and monobehenate, propanediol adipate, propanediol maleate, propanediol dioxalate, propanediol dibenzoate, propanediol diacetate, and all mixtures thereof.

The food compositions of the invention can contain any natural ingredients where appropriate. Natural ingredients include any natural or nature-derived ingredients similar in composition or in function to any of the ingredients listed above.

Food and Beverage Applications

Below is a non-limiting listing of food compositions of the invention comprising the 1,3-propanediol of the invention:

Herbs, seeds, spices, seasonings, blends, extracts, and flavorings, including all natural and artificial spices, blends, and flavors, containing up to about 97% by weight Bio-PDO by weight.

Confections and frostings, including candy and flavored frostings, marshmallows, baking chocolate, and brown, lump, rock, maple, powdered, and raw sugars containing up to about 24% Bio-PDO by weight.

Alcoholic beverages, including malt beverages, wines, distilled liquors, and cocktail mix containing up to about 5% Bio-PDO by weight.

Nuts and nut products, including whole or shelled tree nuts, peanuts, coconut, and nut and peanut spreads, containing up to about 5% Bio-PDO by weight.

Frozen dairy desserts and mixes, including ice cream, ice milks, sherbets, and other frozen dairy desserts and specialties, containing up to about 2.5% Bio-PDO by weight.

Baked goods and baking mixes, including all ready-to-eat and ready-to-bake products, flours, and mixes requiring preparation before serving, containing up to about 2% bio-PDO by weight.

Nonalcoholic beverages and beverage bases, including only special or spiced teas, soft drinks, coffee substitutes, and fruit and vegetable flavored gelatin drinks, containing up to about 2% Bio-PDO by weight.

Breakfast cereals, including ready-to-eat and instant and regular hot cereals, containing up to about 2% Bio-PDO by weight.

Cheeses, including curd and whey cheeses, cream, natural, grating, processed, spread, dip, and miscellaneous cheeses, containing up to about 2% Bio-PDO by weight.

Chewing gum, including all forms, containing up to about 2% Bio-PDO by weight.

Coffee and tea, including regular, decaffeinated, and instant types, containing up to about 2% Bio-PDO by weight.

Condiments and relishes, including plain seasoning sauces and spreads, olives, pickles, and relishes, but not spices or herbs, containing up to about 2% Bio-PDO by weight.

Dairy product analogs, including nondairy milk, frozen or liquid creamers, coffee whiteners, toppings, and other nondairy products, containing up to about 2% Bio-PDO by weight.

Egg products, including liquid, frozen, or dried eggs, and egg dishes made therefrom, i.e., egg roll, egg foo young, egg salad, and frozen multicourse egg meals, but not fresh eggs, containing up to about 2% Bio-PDO by weight.

Fats and oils, including margarine, dressings for salads, butter, salad oils, shortenings and cooking oils, containing up to about 2% Bio-PDO by weight.

Fish products, including all prepared main dishes, salads, appetizers, frozen multicourse meals, and spreads containing fish, shellfish, and other aquatic animals, but not fresh fish, containing up to about 2% Bio-PDO by weight.

Fresh eggs, including cooked eggs and egg dishes made only from fresh shell eggs, containing up to about 2% Bio-PDO by weight.

Fresh fish, including only fresh and frozen fish, shellfish, and other aquatic animals, containing up to about 2% Bio-PDO by weight.

Fresh fruits and fruit juices, including only raw fruits, citrus, melons, and berries, and home-prepared “ades” and punches made therefrom, containing up to about 2% Bio-PDO by weight.

Fresh meats, including only fresh or home-frozen beef or veal, pork, lamb or mutton and home-prepared fresh meat-containing dishes, salads, appetizers, or sandwich spreads made therefrom, containing up to about 2% Bio-PDO by weight.

Fresh poultry, including only fresh or home-frozen poultry and game birds and home-prepared fresh poultry-containing dishes, salads, appetizers, or sandwich spreads made therefrom, containing up to about 2% Bio-PDO by weight.

Fresh vegetables, tomatoes, and potatoes, including only fresh and home-prepared vegetables, containing up to about 2% Bio-PDO by weight.

Fruit and water ices, including all frozen fruit and water ices, containing up to about 2% Bio-PDO by weight.

Gelatins, puddings, and fillings, including flavored gelatin desserts, puddings, custards, parfaits, pie fillings, and gelatin base salads, containing up to about 2% Bio-PDO by weight.

Grain products and pastas, including macaroni and noodle products, rice dishes, and frozen multicourse meals, without meat or vegetables, containing up to about 2% Bio-PDO by weight.

Gravies and sauces, including all meat sauces and gravies, and tomato, milk, buttery, and specialty sauces, containing up to about 2% Bio-PDO by weight.

Hard candy and cough drops, including all hard type candies, containing up to about 2% Bio-PDO by weight.

Jams and jellies, home-prepared, including only home-prepared jams, jellies, fruit butters, preserves, and sweet spreads, containing up to about 2% Bio-PDO by weight.

Jams and jellies, commercial, including only commercially processed jams, jellies, fruit butters, preserves, and sweet spreads, containing up to about 2% Bio-PDO by weight.

Meat products, including all meats and meat containing dishes, salads, appetizers, frozen multicourse meat meals, and sandwich ingredients prepared by commercial processing or using commercially processed meats with home preparation, containing up to about 2% Bio-PDO by weight.

Milk, whole and skim, including only whole, lowfat, and skim fluid milks, containing up to about 2% Bio-PDO by weight.

Milk products, including flavored milks and milk drinks, dry milks, toppings, snack dips, spreads, weight control milk beverages, and other milk origin products, containing up to about 2% Bio-PDO by weight.

Plant protein products, including the National Academy of Sciences/National Research Council “reconstituted vegetable protein” category, and meat, poultry, and fish substitutes, analogs, and extender products made from plant proteins, containing up to about 2% Bio-PDO by weight.

Poultry products, including all poultry and poultry-containing dishes, salads, appetizers, frozen multicourse poultry meals, and sandwich ingredients prepared by commercial processing or using commercially processed poultry with home preparation, containing up to about 2% Bio-PDO by weight.

Processed fruits and fruit juices, including all commercially processed fruits, citrus, berries, and mixtures; salads, juices and juice punches, concentrates, dilutions, “ades”, and drink substitutes made therefrom, containing up to about 2% Bio-PDO by weight.

Processed vegetables and vegetable juices, including all commercially processed vegetables, vegetable dishes, frozen multicourse vegetable meals, and vegetable juices and blends, containing up to about 2% Bio-PDO by weight.

Snack foods, including chips, pretzels, and other novelty snacks, containing up to about 2% Bio-PDO by weight.

Soft candy, including candy bars, chocolates, fudge, mints, and other chewy or nougat candies, containing up to about 2% Bio-PDO by weight.

Soups, home-prepared, including meat, fish, poultry, vegetable, and combination home-prepared soups, containing up to about 2% Bio-PDO by weight.

Soups and soup mixes, including commercially prepared meat, fish, poultry, vegetable, and combination soups and soup mixes, containing up to about 2% Bio-PDO by weight.

Sugar, white, granulated, including only white granulated sugar, containing up to about 2% Bio-PDO by weight.

Sugar substitutes, including granulated, liquid, and tablet sugar substitutes, containing up to about 2% Bio-PDO by weight.

Sweet sauces, toppings, and syrups, including chocolate, berry, fruit, corn syrup, and maple sweet sauces and toppings, containing up to about 2% Bio-PDO by weight.

All of the compositions and methods disclosed and claimed herein can be made and executed without undue experimentation in light of the present disclosure. While the compositions and methods of the present disclosure have been described in terms of preferred embodiments, it will be apparent to those of skill in the art that variations may be applied to the compositions and methods and in the steps or in the sequence of steps of the method described herein without departing from the concept, spirit, and scope of the invention. More specifically, it will be apparent that certain agents, which are chemically related, may be substituted for the agents described herein while the same or similar results would be achieved. All such similar substitutes and modifications apparent to those skilled in the art are deemed to be within the spirit, scope, and concept of the invention as defined by the appended claims.

### EXAMPLES

The present invention is further defined in the following Examples. It should be understood that these Examples, while indicating preferred embodiments of the invention, are given by way of illustration only. From the above discussion and these Examples, one skilled in the art can ascertain the preferred features of this invention, and without departing from the spirit and scope thereof, can make various changes and modifications of the invention to adapt it to various uses and conditions.

### Example 1

Animal feed supplement WO9733488A1

| Ingredient | Weight Percent |
|---|---|
| Sodium Propionate | 10% |
| Bio-PDO | 5% |
| White Grease | 40% |
| Filler | 45% |

(Dairy, fiber, grains, and flavor enhancers)

### Example 2

Energetic feed additive

| Ingredient | Weight Percent |
|---|---|
| Bio-PDO | 25-48% |
| Glycerol | 25-48% |
| Nutritionally suitable acid | 1-17% |
| (e.g. C2-C20 aliphatic carboxylic acids) | |
| Water | 1-32% |
| Vitamins & Minerals | .0001-4% |

### Example 3

Aerosol compositions for animal feeds US2006034978A1

| Ingredient | Weight Percent |
|---|---|
| Molasses | 25% |
| Propylene Glycol | 23% |
| Soy Lecithin | 10% |
| Water | 22% |
| Bio-PDO | 4.5% |
| Flavoring | 0.5% |
| Isobutane/Propane/Butane | 15% |

### Example 4

Flavored Ink Jet Printing Fluid

| Ingredient | Amount |
|---|---|
| Bio-PDO | 94.2% |
| Glycerin | 4.0% |
| FD &C Blue 1 | 1.6% |
| Balls of fire flavor | 0.2% |

### Example 5

Berry Flavor Concentrate

| Ingredient | Amount |
|---|---|
| Bio-PDO | 53% |
| Ethanol | 10% |
| Water | 30% |
| Berry flavor | 3% |
| Citric acid | 4% |

### Example 6

Edible Pet Chew

| Ingredient | Amount |
|---|---|
| Proteins | 5-50% |
| Carbohydrates | 20-80% |
| Bio-PDO | 5-50% |
| Water | 5-30% |

### Example 7

Low calorie sugar substitute

| Ingredient | Amount |
|---|---|
| Sorbitol | 48.34% |
| Water | 48.34% |
| Sodium alginate | 0.4% |
| Calcium sulfate dihydrate | 0.3% |
| Guar gum | 1.0% |
| Wheat plant fiber | 0.5% |
| Bio-PDO | 1.0% |
| Neotame | 0.02% |
| Potassium sorbate | 0.1% |

### Example 8

Ice cream toppings

| Ingredient | Amount |
|---|---|
| Flavoring agent | 0.05-40% |
| Fat | 0.01-50% |
| Bio-PDO | 0.1-40% |
| Sweetener | up to 80% |
| Emulsifier | up to 10% |
| Water | 0-20% |

### Example 9

Frozen beverage

| Ingredient | Amount |
|---|---|
| Water | 60.6% |
| Bio-PDO | 20.2% |
| Polyethylene | 18.3% |
| Propylene glycol alginate | 0.7% |
| Caramel colorant | 0.2% |

### Example 10

Flavor delivery system

| Ingredient | Amount |
|---|---|
| Benzaldehyde | 20% |
| Polysorbate 80 | 40% |
| Bio-PDO | 40% |

### Example 11

Soft-frozen cocktail drink

| Ingredient | Amount |
|---|---|
| Ethanol | 2-15% |
| Bio-PDO | 12-14% |
| Base flavor mix | q.s. to 100% |

### Example 12

Flavored micro emulsion for Beverages

| Ingredient | Amount |
|---|---|
| Flavor oil | 4.1% |
| Tween-60 | 4.1% |
| Water | 16.5% |
| Bio-PDO | 75.4% |

### Example 13

Food flavoring material

| Ingredient | Amount | |
|---|---|---|
| Glutamate | 9.5 | g |
| IMP | 0.25 | g |
| GMP | 0.25 | g |
| Lactose | 5.0 | g |
| Sodium chloride | 10.0 | g |
| Water | 60.0 | kg |
| Bio-PDO | 15.0 | kg |

### Example 14

Heat-stable flavoring

| Ingredient | Amount |
|---|---|
| Tamarind seed gum | 50 g |
| Bio-PDO | 50 g |
| Water | 200 g |
| Sodium pyrophosphate | 3 g |

### Example 15

Fried Food Preservative

| Ingredient | Amount |
|---|---|
| Soybean oil | 75 parts |
| Lecithin | 20 parts |
| Bio-PDO | 5 parts |

### Example 16

Non-aqueous Beverage Gel

| Ingredient | Amount |
|---|---|
| Me cellulose | 10 parts |
| Bio-PDO | 100 parts |

### Example 17

Food Preservation Emulsifier

| Ingredient | Amount |
|---|---|
| Capric acid monoglyceride | 75% |
| Bio-PDO | 15% |
| Water | 7% |
| Sodium glutamate | 3% |

### Example 18

Liquid Heat-Setting Confections

| Ingredient | Amount |
|---|---|
| Bio-PDO | 17.7% |
| Glycerol monooleate | 0.7% |
| Lecithin | 0.7% |
| Antioxidant | 0.0% |
| Honey | 0.1% |
| Coloring | 0.3% |
| Flavoring | 0.3% |
| Potassium citrate | 1.2% |
| Artificial sweetener | 0.2% |
| Glycerol | 53.1% |
| Starch | 23.6% |
| Carrageenan | 2.1% |

### Example 19

Instant dumplings

| Ingredient | Amount |
|---|---|
| Flour | 40-60 parts |
| Potato starch | 20-30 parts |
| Acetic acid starch | 10-20 parts |
| Refined salt | 0.5-5 parts |
| Emulsifying agent | 0.2-1 parts |
| Sorbitol | 2-8 parts |
| Bio-PDO | 2-6 parts |

### Example 20

Grated Cheese Preservative

| Ingredient | Amount | |
|---|---|---|
| Bio-PDO | 20 | parts |
| Sodium chloride | 18 | parts |
| Lactic acid | 0.1 | parts |
| Propionic acid | 0.1 | parts |
| Sucrose | 2 | parts |
| Ascorbic acid | 0.05 | parts |
| Glycerol monostearate | 0.1 | parts |
| Water | 59.65 | parts |

### Example 21

Edible solid for confectionery coatings or cake or cookie dough

| Ingredient | Amount |
|---|---|
| Bio-PDO | 80% |
| Nonfat dry milk solid | 20% |

### Example 22

Ready-made/Instant Food Preservative

| Ingredient | Amount | |
|---|---|---|
| Bio-PDO | 50 | parts |
| Acetic acid | 3 | parts |
| Sodium acetate | 1.5 | parts |
| Ethanol (95%) | 105.3 | parts |

### Example 23

Multi-phase delivery system for food supplements and meal replacements

| Ingredient | Amount |
|---|---|
| Creatine monohydrate | 16.71% |
| Glycerol | 15.97% |
| Corn syrup | 21.20% |
| High-fructose corn syrup | 24.78% |
| Gelatin | 5.51% |
| Bio-PDO | 5.51% |
| Modified starch | 2.75% |
| Water | 4.96% |
| Other ingredients | 2.61% |

### Example 24

Mulberry Leaf Preservative

| Ingredient | Wt, % | Overall |
|---|---|---|
| Actives | | 3-8% |
| pH regulator | | 20-30% |
| Malic acid | 1-35% | |
| Citric acid | 18-25% | |
| Sorbic acid | 15-20% | |
| Hydrochloric acid | 8-14% | |
| Phytic acid | 16-25% | |
| Dewatered acetic acid | 8-15% | |
| Redox agent | | 20-30% |
| Sodium sulfate | 15-25% | |
| Potassium sulfate | 18-28% | |
| Pepsin | 25-40% | |
| Papain | 5-42% | |
| Moisture activity-reducing agent | | 20-30% |
| Sodium pyrophospahte | 10-15% | |
| Sodium chloride | 6-10% | |
| Bio-PDO | 8-15% | |
| Agar | 5-40% | |
| Kara gum | 15-25% | |
| Gelatin | 21-30% | |
| Disinfectant | | 15-25% |
| Josamycin | 15-40% | |
| Fupaisuan | 18-25% | |
| Phage | 22-30% | |
| Lysozyme | 20-30% | |
| Water | | q.s, to 100% |

### Example 25

Fining product

| Ingredient | Amount |
|---|---|
| Collagen | 3-40% |
| Bio-PDO | 2-50% |
| Buffering system | 0.5-5% |
| Preservative | 0.1-5% |

### Example 26

Semi-moist feed for herbivorous animals

| Ingredient | Amount |
|---|---|
| Gelatinized starch | 5-55% |
| Sugars | 5-80% |
| Bio-PDO | 2-8% |
| Water | 15-30% |

### Example 27

Preservative for bakery products

| Ingredient | Amount |
|---|---|
| Ethanol | 1.0% |
| Bio-PDO | 0.5% |
| Acetic acid | 0.03% |
| Sodium acetate | 0.02% |
| Water | 98.45% |

(Sweet rice flour 600 g, water 400 mL and preservative 16 g)

### Example 28

Food moistening agent for starch and(or) protein raw materials

| Ingredient | Amount |
|---|---|
| Bio-PDO | 40-90% |
| Sorbitol | 10-60% |

(Fish cake (kamaboko) 96% and moistening agent 4%)

### Example 29

Solid food condiment

| Ingredient | Amount |
|---|---|
| Bio-PDO | 1-70 parts |
| Gelatin | 10 parts |
| Condiment* | 80-93% total solids |

*Catsup, vinegar, apple butter, dried onion flakes, mustard, pickle relish

### Example 30

Microbial stabilized cooked dehydrated meat, vegetables, or fruits

| Ingredient | Amount |
|---|---|
| Freeze-dried chicken solids | 34.3% |
| Glycerol | 32.4% |
| H2O | 27.8% |
| Salt | 0.8% |
| Sugar | 1.5% |
| Monosodium glutamate | 1.8% |
| Bio-PDO | 1.1% |
| Potassium sorbate | 0.3% |

### Example 31

Stable emulsifier for sponge cakes and creams

| Ingredient | Amount | |
|---|---|---|
| Sorbitol (70%) | 570 | g |
| Bio-PDO | 200 | g |
| Ethanol | 20 | g |
| Water | 800 | g |
| Sucrose monosterate | 160 | g |
| Sodium hydroxide (10%) | 16 | ml |
| Propylene glycol monostearate | 40 | g |
| Glycerol monostearate | 200 | g |

### Example 32

Fruit coating

| Ingredient | Amount |
|---|---|
| Bio-PDO | 5% |
| Water | 45% |
| Ethanol | 50% |

### Example 33

Frozen or processed meats coating

| Ingredient | Amount |
|---|---|
| cellulose propionate flake | 45 parts |
| acetyl tributyl citrate | 55 parts |
| Bio-PDO | 5 parts |

### Example 34

Stabilizer for semidry feeds

| Ingredient | Amount |
|---|---|
| Bio-PDO | 51.2% |
| Glycerol | 35.3% |
| Sorbitol | 13.5% |

### Example 35

Brine solution for freezing fresh foods (fish, meat, vegetable, etc)

| Ingredient | Amount |
|---|---|
| Ethanol | 40-60% |
| Bio-PDO | 2-20% |
| Preservatives | 0.05-1% |
| H2O | q.s. to 100% |

### Example 36

Lycopene pigment

| Ingredient | Amount | |
|---|---|---|
| Lycopene pigment | 0.8 | g |
| Natural vitamin E | 0.2 | g |
| d-limonene | 2 | g |
| Palm oil | 5 | g |
| SAIB | 6 | g |
| Water | 60 | g |
| Arabic gum | 20 | g |
| L-ascorbic acid | 0.1 | g |
| Bio-PDO | 10 | g |

### Example 37

Low Calorie Honey Substitute

| Ingredient | Amount |
|---|---|
| CM-cellulose gum | 0.500% |
| HPM-cellulose gum | 0.500% |
| Xanthan gum | 0.223% |
| Propylene glycol alginate | 0.0525% |
| Sodium bicarbonate | 0.131% |
| Glycerin | 5.91% |
| Bio-PDO | 1.31% |
| Aspartame | 0.223% |
| Acesulfame K | 0.0421% |
| Food Color Blend | 0.237% |
| Honey Flavor | 0.17% |
| Vanilla extract | 0.0657% |
| Water | 90.7% |

### Example 38

Fabricated fruit pieces

| Ingredient | Wt % | % of Piece |
|---|---|---|
| Soft Berry Center | | 90.0% |
| Corn syrup | 20.3% | |
| Blueberry Flavor | 1.1% | |
| Bio-PDO | 52.8% | |
| Water | 7.2% | |
| Modified corn starch | 5.4% | |
| Modified tapioca starch | 5.5% | |
| Fructose | 4.0% | |
| Malic acid | 0.7% | |
| Citric acid | 1.0% | |
| Grape skin extract color | 1.0% | |
| Dried blueberry powder | 0.5% | |
| Salt | 0.5% | |
| | 100% | |
| Thin Film Coating | | 10.0% |
| Sodium citrate | 0.23% | |
| Water | 76.98% | |
| Gellan gum | 0.59% | |
| Citric acid | 0.20% | |
| Sucrose | 10.0% | |
| Grape skin extract color | 0.5% | |
| Blueberry powder | 0.5% | |
| Bio-PDO | 10.0% | |
| Sunflower oil | 0.5% | |
| | 100% | |

We claim:

1. A food composition comprising 1,3-propanediol and a food ingredient, wherein said 1,3-propanediol has a bio-based carbon content of at least 1%.

2. The food composition of claim 1 wherein the 1,3-propanediol has at least 5% biobased carbon.

3. The food composition of claim 1 wherein the 1,3-propanediol has at least 10% biobased carbon.

4. The food composition of claim 1 wherein the 1,3-propanediol has at least 25% biobased carbon.

5. The food composition of claim 1 wherein the 1,3-propanediol has at least 50% biobased carbon.

6. The food composition of claim 1 wherein the 1,3-propanediol has at least 75% biobased carbon.

7. The food composition of claim 1 wherein the 1,3-propanediol has at least 90% biobased carbon.

8. The food composition of claim 1 wherein the 1,3-propanediol has at least 99% biobased carbon.

9. The food composition of claim 1 wherein the 1,3-propanediol has 100% biobased carbon.

10. The food composition of claim 1 wherein the 1,3-propanediol is biologically-derived.

11. The food composition of claim 10 wherein the biologically-derived 1,3-propanediol is biologically produced through a fermentation process.

12. A food composition comprising 1,3-propanediol wherein said 1,3-propanediol has an ultraviolet absorption at 220 nm of less than about 0.200 and at 250 nm of less than about 0.075 and at 275 nm of less than about 0.075.

13. The food composition of claim 12 wherein said 1,3-propanediol has a “b” color value of less than about 0.15 and an absorbance at 275 nm of less than about 0.050.

14. The food composition of claim 14 wherein said 1,3-propanediol has a peroxide concentration of less than about 10 ppm.

15. The food composition of claim 14 wherein said 1,3-propanediol has a concentration of total organic impurities in said composition of less than about 400 ppm.

16. The food composition of claim 14 wherein said 1,3-propanediol has a concentration of total organic impurities of less than about 300 ppm.

17. The food composition of claim 14 wherein said 1,3-propanediol has a concentration of total organic impurities of less than about 150 ppm.

18. A food composition comprising 1,3-propanediol wherein said 1,3-propanediol has a concentration of total organic impurities of less than about 400 ppm.

19. The food composition claim 18 wherein said 1,3-propanediol has a concentration of total organic impurities of less than about 300 ppm.

20. The food composition claim 18 wherein said 1,3-propanediol has a concentration of total organic impurities of less than about 150 ppm.

21. The food composition claim 18 wherein said 1,3-propanediol has a concentration of peroxides of less than about 10 ppm.

22. The food composition claim 18 wherein said 1,3-propanediol has a concentration of carbonyl groups of less than about 10 ppm.

23. A food composition comprising 1,3-propanediol, wherein the 1,3-propanediol in said composition has an anthropogenic CO₂ emission profile of zero upon biodegradation.
